(19) United States
(12) Patent Application Publication
(10) Pub. No.: US 2010/0100016 A1
(43) Pub. Date: Apr. 22, 2010

(54) PLATFORM ASSEMBLY FOR A VIBRATION EXERCISER

(76) Inventor: Mu-Chuan WU, Hsi-Kang Hsiang (TW)

Correspondence Address: Rahman LLC, 10025 Governor Warfield Parkway, Suite 110, Columbia, MD, 21044, US

(21) Appl. No.: 12/254,109

(22) Filed: Oct. 20, 2008

(51) Int. Cl. A61H 1/00

(52) U.S. Cl. 601/30

(57) ABSTRACT

A platform assembly for a vibration exerciser has a base, a platform, a vibration generator and a resilient assembly. The platform is connected operationally to the base and has a bottom. The vibration generator is attached to the bottom of the platform to make the platform vibration. The resilient assembly is mounted around the base and is connected to the platform along a lateral direction. Accordingly, the vibration exerciser platform assembly can provide a gentle vibration force to a user to keep the user from being injured.

### BACKGROUND OF THE INVENTION

1. Field of the Invention

The present invention relates to a platform assembly, and more particularly to a platform assembly for a vibration exerciser.

2. Description of Related Art

A vibration exerciser has a vibrated platform assembly to provide a vibrating effect to a user who steps, sits or lies or abuts on the platform for training or exercising muscles of the user.

With reference to FIGS. 9 and 10, a conventional platform assembly for a vibration exerciser comprises a base (70), multiple supporting members (71), a platform (72) and a vibration generator (73). The supporting members (71) are securely attached to the base (70) along a direction vertical to the base (70) and each has a spring. The platform (72) is connected to and supported by the tops of the supporting members (71). The vibration generator (73) is securely attached to the bottom of the platform (72) to make the platform (72) vibration.

With reference to FIG. 11, another conventional platform assembly for a vibration exerciser comprises a base (80), multiple lower resilient elements (81), a supporting board (82), multiple upper resilient elements (83), a platform (84) and a vibration generator (85). The lower resilient elements (81) are mounted securely on the base (80). The supporting board (82) is attached securely to and supported by the lower resilient elements (81). The upper resilient elements (83) are attached securely to the top of the supporting board (82). The platform (84) is mounted on and supported by the upper resilient elements (83). The vibration generator (85) is securely attached to the bottom of the platform (84) to make the platform (84) vibration.

By researches, there are three indexes including frequency, amplitude and acceleration will influence the vibration effect provided to a user. However, the supporting members (71) and the resilient elements (81, 83) of the conventional platform assemblies support the platform (72, 84) along a direction substantially vertical to the corresponding base (70, 80), so the vibration action of the platform (72, 84) will impact the user directly. Consequently, less vibration force cannot provide enough training and exercising effect, but a user is easily injured by a large longitudinal vibration force.

To overcome the shortcomings, the present invention tends to provide a platform assembly for a vibration exerciser to mitigate or obviate the aforementioned problems.

### SUMMARY OF THE INVENTION

The main objective of the invention is to provide a platform assembly for a vibration exerciser that can provide gentle and adjustable vibration force to a user.

The platform assembly comprises a base, a platform, a vibration generator and a resilient assembly. The platform is connected operationally to the base and has a bottom. The vibration generator is attached to the bottom of the platform to make the platform vibration. The resilient assembly is mounted around the base and is connected to the platform along a lateral direction.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a platform assembly for a vibration exerciser in accordance with the present invention;

FIG. 2 is a top view in partial section of the platform assembly in FIG. 1;

FIG. 3 is a side view of the platform assembly in FIG. 1;

FIG. 4 is a top view in partial section of a second embodiment of a platform assembly in accordance with the present invention;

FIG. 5 is a top view in partial section of a third embodiment of a platform assembly in accordance with the present invention;

FIG. 6 is a side view in partial section of the platform assembly in FIG. 4 or 5;

FIG. 7 is an enlarged side view in partial section of the platform assembly in FIG. 6;

FIG. 8 is a side view of a fourth embodiment of a platform assembly in accordance with the present invention;

FIG. 9 is an exploded perspective view of a conventional platform assembly for a vibration exerciser in accordance with the prior art;

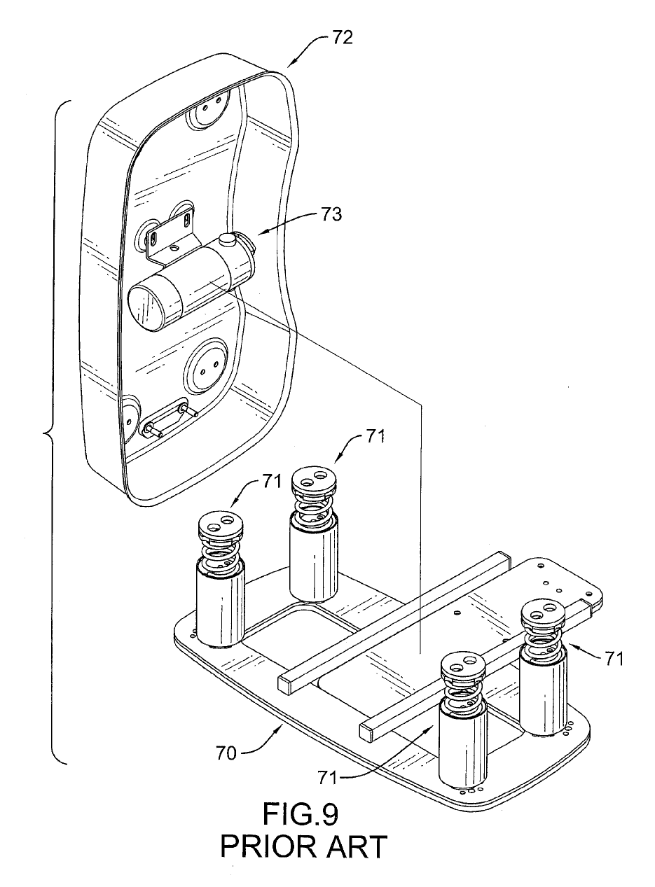

FIG. 10 is a side view of the platform assembly in FIG. 9; and

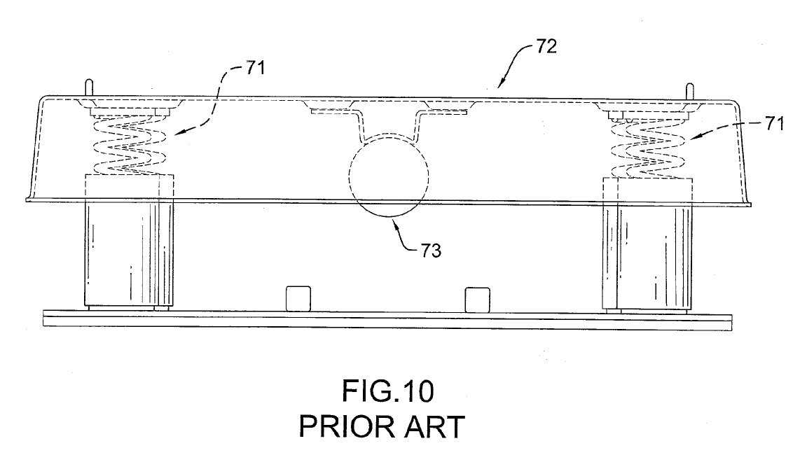

FIG. 11 is a side view of another conventional platform assembly for a vibration exerciser in accordance with the prior art.

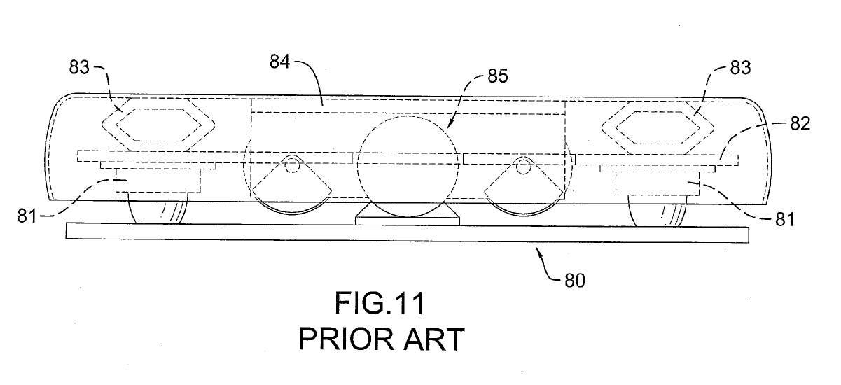

### DETAILED DESCRIPTION OF PREFERRED EMBODIMENT

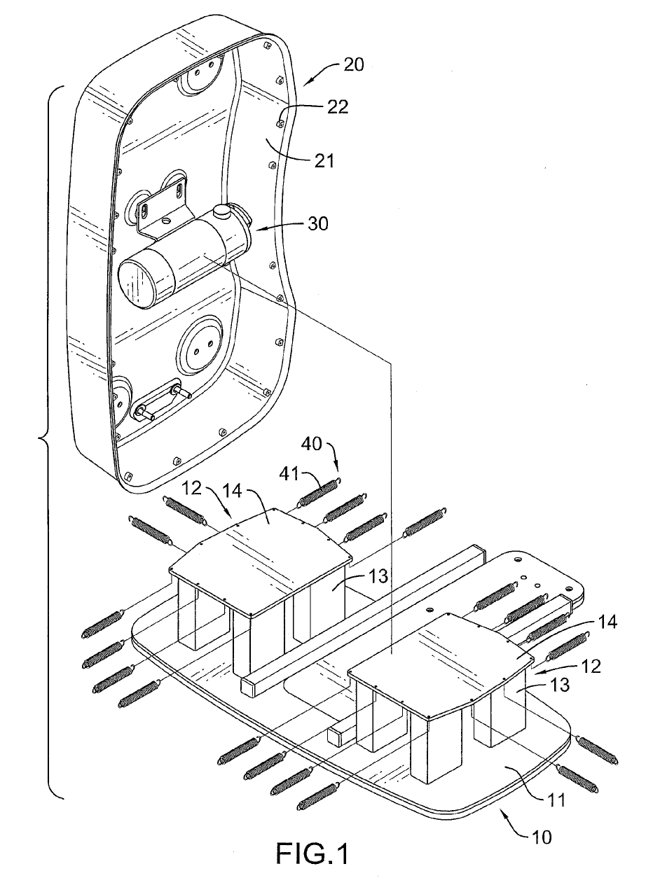

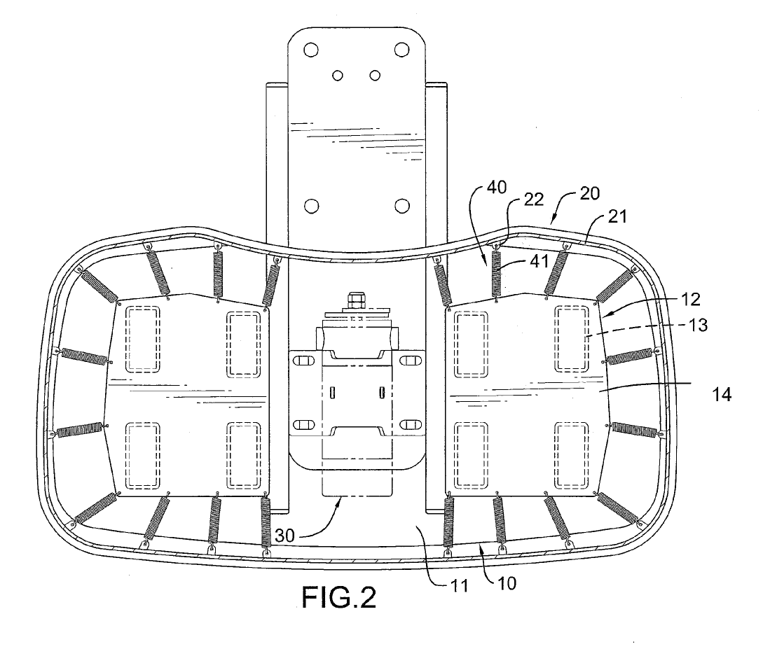

With reference to FIGS. 1 to 5, a platform assembly for a vibration exerciser in accordance with the present invention comprises a base (10), a platform (20), a vibration generator (30) and a resilient assembly (40). The base (10) comprises a rectangular bottom panel (11) and two supporting brackets (12). The supporting brackets (12) are securely attached to the bottom panel (11) and each has multiple supporting posts (13) and a top panel (14). The supporting posts (13) are securely attached to the top of the bottom panel (11), and the top panel (14) is securely attached to the tops of the supporting posts (13).

The platform (20) is connected operationally to the base (10) and has a side wall (21) formed around and extending downward from the periphery of the platform (20) to define a chamber in the platform (20). The side wall (21) has multiple connecting elements (22) defined on the side wall (21). In a preferred embodiment, each connecting element (22) is a hole defined in the side wall (21).

The vibration generator (30) is attached to the bottom of the platform (20) to make the platform (20) vibration. The vibration generator (30) may be a mechanical vibration generator having a motor with a cam or an eccentric block or levers, sound waves type vibration generator or any possible conventional vibration generating device.

The resilient assembly (40) is mounted around the base (10) and is connected to the platform (20) along a lateral direction that is substantially parallel with the bottom panel (11) of the base (10).

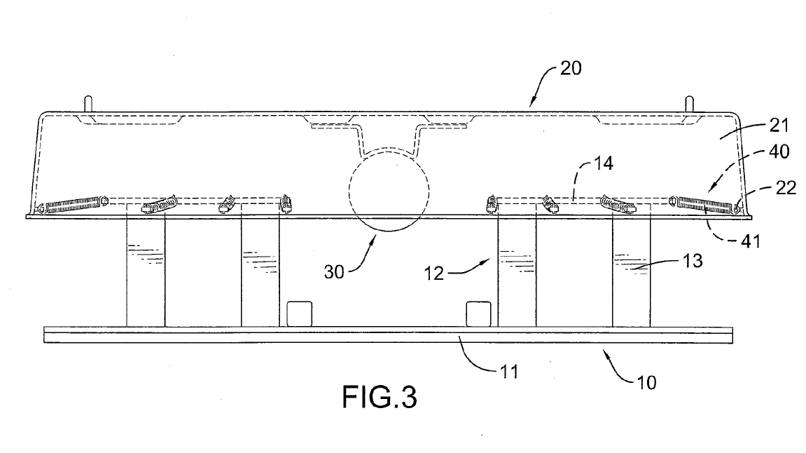

With reference to FIGS. 1 and 3, in a first embodiment, the resilient assembly (40) comprises multiple springs (41). Each spring (41) has two ends connected respectively to a side of the base (10) and a side of the platform (20).

In the preferred embodiment, one end of each spring (41) is connected to a hole defined in the top panel (14) of one of the supporting brackets (12). The other end of each spring (41) is connected to one of the connecting elements (22) on the side wall (21) of the platform (20).

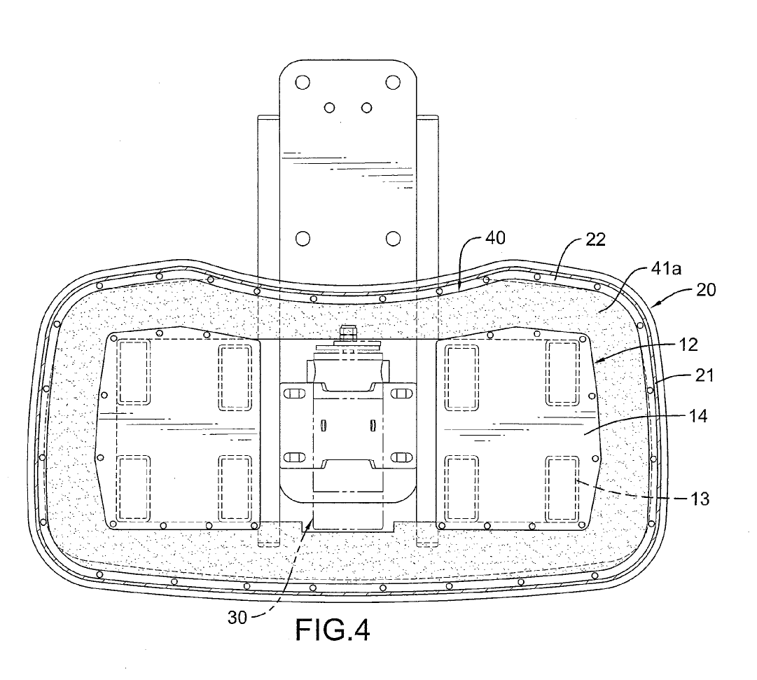

With reference to FIG. 4, in a second embodiment, the resilient assembly (40) comprises an annular resilient sheet (41a) mounted around the base (10) and held inside the chamber in the platform (20). The resilient sheet (41a) is made of rubber material and has an inner edge and an outer edge. The inner edge of the resilient sheet (41a) is securely attached to and mounted around the base (10) with multiple connecting members. The outer edge of the resilient sheet (41a) is securely attached to the platform (20) with multiple connecting members. The connecting members may be bolts, nails, hooks, loops or the like.

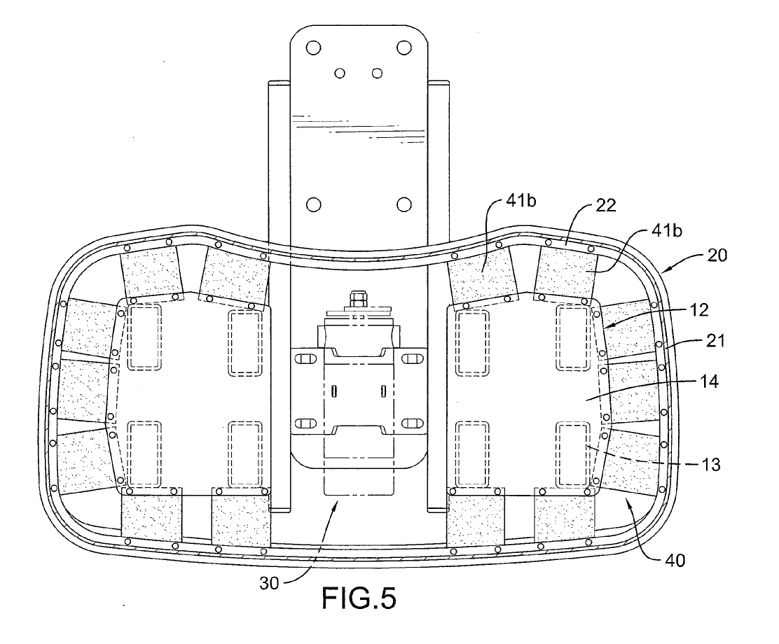

With reference to FIG. 5, in a third embodiment, the resilient assembly (40) comprises multiple resilient bodies (41b) mounted around the base (10) at intervals and held inside the chamber in the platform (20). Each resilient body (41b) is made of rubber material and has an inner side and an outer side. The inner side of the resilient sheet (41b) is securely attached to a side of the top panel (14) of one of the supporting brackets (12) on the base (10) with multiple connecting members. The outer side of the resilient body (41b) is securely attached to a side of the side wall (21) on the platform (22) with multiple connecting members. The connecting members may be bolts, nails, hooks, loops or the like.

In use, a user can step, sit, lie or abut on the platform (22) and turns on the vibration generator (30) to make the platform (20) vibrating and shocking. With the vibration of the platform (20), muscles of the user can be excited and provided with a training and exercising effect. With the resilient assembly (40) arranged along a lateral direction, part of the vibration force applied to the platform (20) will be transferred to a lateral component force to make the force applied to the user becoming gentle and comfortable. With the gentle vibration force due to the arrangement of the lateral resilient assembly (40), the user can be kept from being injured.

In addition, when the resilient assembly (40) is implemented with the annular resilient sheet (41a) or multiple resilient bodies (41b), the inner surface of the side wall (21) on the platform (20) and the periphery of the top panel (14) of each supporting bracket (12) on the base are curved at corners to keep the resilient sheet (41a) or bodies (41b) from being damaged.

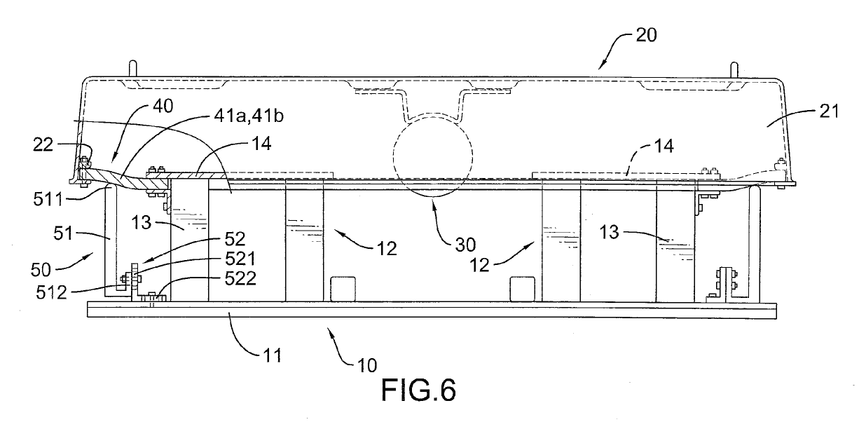

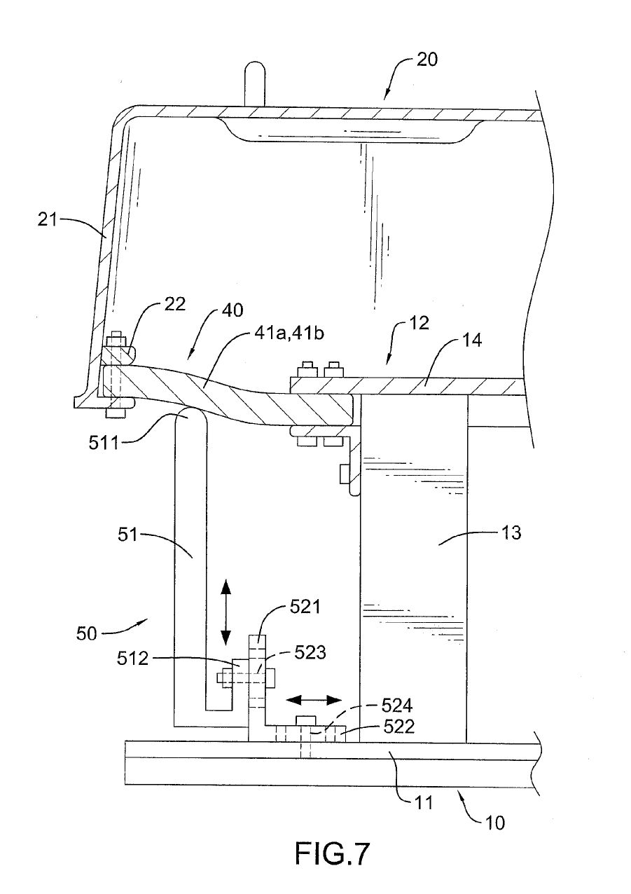

Additionally, when the resilient assembly (40) is implemented with the annular resilient sheet (41a) or multiple resilient bodies (41b), the platform assembly may further comprise an auxiliary supporting device (50) as shown in FIGS. 6 and 7. The auxiliary supporting device (50) has at least one supporting member (51) connected to the base (10) and abutting with the resilient assembly (40). In a preferable embodiment, the auxiliary supporting device (50) has multiple supporting members (51). Each supporting member (51) has a convex abutting end (511) abutting with a bottom of the resilient sheet (41a) or one of the resilient bodies (41b). Each supporting member (51) may have a positioning tab (512) formed on and extending longitudinally from a side of the supporting member (51).

The auxiliary supporting device (50) may further comprise multiple adjusting elements (52) connected respectively to the supporting members (51) to adjust a position where the abutting end (511) of each supporting member (51) abuts with the resilient sheet (41a) or a corresponding resilient body (41b). Each adjusting element (52) is L-shaped and comprises a longitudinal tab (521) and a lateral tab (522). The longitudinal tab (521) is connected adjustably to the positioning tab (512) of a corresponding supporting member (51), and the lateral tab (522) is attached adjustably to the bottom panel (11) of the base (10). To adjustably connect the longitudinal tab (521) to the corresponding positioning tab (512), the positioning tab (512) has a through hole defined through the positioning tab (512). The longitudinal tab (521) has multiple through holes or an elongated slot defined through the longitudinal tab (521). A fastener extends through the through hole in the positioning tab (512) and one of the through holes or the slot in the longitudinal tab (521), such that the positioning tab (512) is connected adjustably to the longitudinal tab (521) with the fastener. To adjustably connect the lateral tab (522) to the base (10), the lateral tab (522) has multiple through holes or an elongated slot defined through the lateral tab (522).

A fastener extends through one of the through holes or the slot in the lateral tab (522) and the base (10) to make the lateral tab (522) connected adjustably to the base (10).

With the arrangement of the adjusting elements (52), the longitudinal heights and lateral positions of the abutting ends (511) of the supporting members (51) abutting with the resilient sheet (41a) or the resilient bodies (41b) can be changed. With the change of the abutting positions between the supporting members (51) and the resilient assembly (40), the vibration force and the amplitude of vibration of the platform (20) can be adjusted due to the following formula:

$$F = m \cdot a = \frac{m \cdot 4 {π}^{2} \cdot r}{{T}^{2}} = \frac{m \cdot {v}^{2}}{r} = m \cdot r \cdot ω ; and$$

wherein, F is the vibration force that is a centrifugal force, m is the mass of the resilient sheet/body, r is radius of vibration of the resilient sheet/body, T is the cycle of vibration, v is the speed and ω is angular speed.

With the adjustable vibration force and amplitude of vibration, the training and the exercising effects provided by the platform assembly can be improved and the platform assembly is versatile in use.

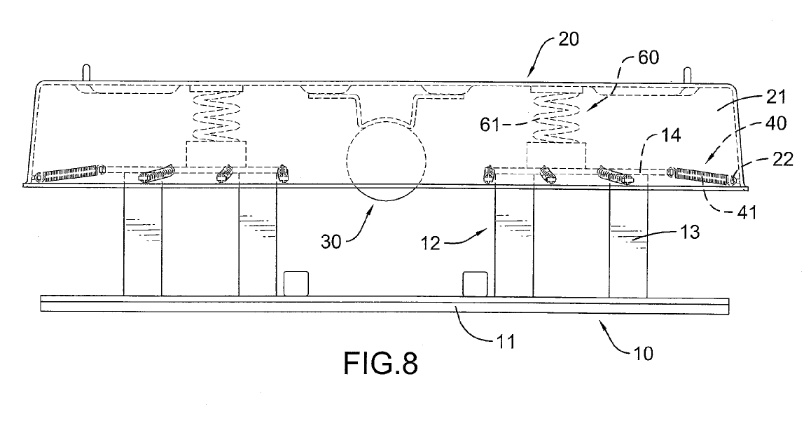

With reference to FIG. 8, the platform assembly in accordance with the present invention may further comprises a resilient supporting device (60) mounted on the top of the base (10) and connected to the bottom of the platform (20). The resilient supporting device (60) may comprises at least one spring (61) attached to the top panels (14) of the base (10) and connected to the bottom of the platform (20) to provide a longitudinal and auxiliary supporting effect to the platform (20).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A platform assembly for a vibration exerciser comprising:
a base;
a platform connected operationally to the base and having a bottom;
a vibration generator attached to the bottom of the platform to make the platform vibration; and
a resilient assembly mounted around the base and connected to the platform along a lateral direction.

2. The platform assembly for a vibration exerciser as claimed in claim 1, wherein the resilient assembly comprises multiple springs each having two ends connected respectively to a side of the base and a side of the platform.

3. The platform assembly for a vibration exerciser as claimed in claim 2 further comprising a resilient supporting device mounted on a top of the base and connected to the bottom of the platform.

4. The platform assembly for a vibration exerciser as claimed in claim 1, wherein the resilient assembly comprises an annular resilient sheet having:
an inner edge securely attached to and mounted around the base; and
an outer edge securely attached to the platform.

5. The platform assembly for a vibration exerciser as claimed in claim 4 further comprising an auxiliary supporting device having at least one supporting member connected to the base and abutting with the resilient sheet, wherein each one of the at least one supporting member has a convex abutting end abutting with a bottom of the resilient sheet.

6. The platform assembly for a vibration exerciser as claimed in claim 5, wherein the auxiliary supporting device further comprises at least one adjusting element connected respectively to the at least one supporting member to adjust a position where the abutting end of each one of the at least one supporting member abuts with the resilient sheet.

7. The platform assembly for a vibration exerciser as claimed in claim 6, wherein each one of the at least one supporting member has a positioning tab formed on and extending longitudinally from a side of the supporting member; and
each one of the at least one adjusting element is L-shaped and comprises:
a longitudinal tab connected adjustably to the positioning tab of a corresponding one of the at least one supporting member; and
a lateral tab attached adjustably to the base.

8. The platform assembly for a vibration exerciser as claimed in claim 7 further comprising a resilient supporting device mounted on a top of the base and connected to the bottom of the platform.

9. The platform assembly for a vibration exerciser as claimed in claim 1, wherein the resilient assembly comprises multiple resilient bodies each having:
an inner side securely attached to a side of the base; and
an outer side securely attached to a side of the platform.

10. The platform assembly for a vibration exerciser as claimed in claim 9 further comprising an auxiliary supporting device having multiple supporting members connected to the base and abutting respectively with the resilient bodies, wherein each supporting member has a convex abutting end abutting with a bottom of one of the resilient bodies.

11. The platform assembly for a vibration exerciser as claimed in claim 10, wherein the auxiliary supporting device further comprises multiple adjusting elements connected respectively to the supporting members to adjust a position where the abutting end of each supporting member abuts with a corresponding resilient body.

12. The platform assembly for a vibration exerciser as claimed in claim 11, wherein each supporting member has a positioning tab formed on and extending longitudinally from a side of the supporting member; and
each adjusting element is L-shaped and comprises:
a longitudinal tab connected adjustably to the positioning tab of a corresponding one of the supporting members; and
a lateral tab attached adjustably to the base.

13. The platform assembly for a vibration exerciser as claimed in claim 12 further comprising a resilient supporting device mounted on a top of the base and connected to the bottom of the platform.

14. The platform assembly for a vibration exerciser as claimed in claim 1 further comprising a resilient supporting device mounted on a top of the base and connected to the bottom of the platform.
